(19) United States
(12) Patent Application Publication
(10) Pub. No.: US 2026/0329935 A1
(43) Pub. Date: Oct. 22, 2026

(54) LOG DATA ANALYSIS DEVICE, LOG DATA ANALYSIS METHOD, AND LOG DATA ANALYSIS PROGRAM

(71) Applicant: NTT, INC, Tokyo (JP)

(72) Inventors: Yoshifumi FUKUMOTO, Tokyo (JP); Hisashi KURASAWA, Tokyo (JP); Miyuki IMADA, Tokyo (JP); Masakuni ISHII, Tokyo (JP); Kensuke FUKUSHIMA, Tokyo (JP); Tetsuya SHIODA, Tokyo (JP); Susumu YAMAMOTO, Tokyo (JP)

(73) Assignee: NTT, INC, Tokyo (JP)

(21) Appl. No.: 18/880,829

(22) PCT Filed: Jul. 5, 2022
(86) PCT No.: PCT/JP2022/026732

§ 371 Date: Jan. 2, 2025

(51) Int. Cl. G06F 16/901

(52) U.S. Cl. CPC G06F 16/901

(57) ABSTRACT

A log data analysis device 10 includes an acquisition unit 101 that acquires log data in which a user action and one or more attributes associated with the action are described, a selection unit 102 that selects a combination of the attributes of the log data acquired by the acquisition unit 101 on the basis of the action of the log data and the number of pieces of unique data in the combination of the attributes associated with the action, and an analysis unit 103 that analyzes the log data by a predetermined language model using the combination of the attributes of the log data selected by the selection unit 102.

### TECHNICAL FIELD

The disclosed technology relates to a log data analysis device, a log data analysis method, and a log data analysis program.

### BACKGROUND ART

In the natural language processing field, a language model technology (BERT or the like) that acquires a meaning of each word in a context from a large number of documents has become widespread. The language model is developed in other fields, and is used in, for example, a recommendation system (BERT4Rec or the like) that acquires a meaning of each action in a context from a large amount of action logs and proposes a next action. Non Patent Literature 1 discloses BERT4Rec, for example.

### CITATION LIST

### Non Patent Literature

Non Patent Literature 1: Fei Sun, Jun Liu, Jian Wu, Changhua Pei, Xiao Lin, Wenwu Ou, Peng Jiang BERT4Rec: Sequential Recommendation with Bidirectional Encoder Representations from Transformer, Internet <URL: https://arxiv.org/abs/1904.06690>

### SUMMARY OF INVENTION

### Technical Problem

Conventionally, as a method for analyzing user actions from action logs collected across services, attempts have been made to apply a language model by regarding a combination of attributes of logs as a word. An identifier corresponding to a word in a natural language is an identifier configured by a combination of one or more attributes in the action log. The attribute varies depending on the type of action such as a name of a product or service, a channel, and a classification category, and it is necessary to design how to combine the attributes at the time of applying a language model technology.

Here, when a combination of all the attributes of the logs of the user are regarded as a word, in application of the language model, the combination of the attributes is regarded as one word in the language model, a unique ID is assigned to each combination of the values of the attributes, and when processing is performed to express the one word, dictionary data indicating a correspondence relationship between each combination of the values of attributes and the ID required in the processing becomes enormous. When the dictionary data becomes enormous, there is a problem that the primary storage area (memory) under processing becomes insufficient and the processing cannot be completed. A shortage problem can be avoided by using a secondary storage area such as a hard disk drive (HDD) or a solid state drive (SSD) instead of the primary storage area. However, each time the dictionary is referred to, it is required to perform processing of searching the secondary storage area for a corresponding value and updating the value. Therefore, the calculation cost increases, and the processing cannot be performed in a realistic time. If a specific attribute of the logs of the user is selected to narrow down the number of words, it is necessary to identify the user action at an appropriate granularity in applying the language model technology, since meaningful attributes vary depending on the types of the logs. If any one of the attributes is selected and used as the identifier of the action logs, the granularity of the action becomes coarse, and it becomes difficult to distinguish the characteristic tendency of the action that can be estimated from the language model. When all attributes are selected and used as the identifier of the action logs, the granularity of the action becomes excessively fine and it becomes impossible to acquire the characteristic tendency of the action that can be estimated from the language model.

The disclosed technology has been made in view of the above points, and an object thereof is to provide a log data analysis device, a log data analysis method, and a log data analysis program for analyzing log data by a combination including many action characteristics while suppressing a calculation cost.

### Solution to Problem

A first aspect of the present disclosure is a log data analysis device including: an acquisition unit that acquires log data in which a user action and one or more attributes associated with the action are described; a selection unit that selects a combination of the attributes of the log data acquired by the acquisition unit on the basis of the action of the log data and the number of pieces of unique data in the combination of the attributes associated with the action; and an analysis unit that analyzes the log data by a predetermined language model using the combination of the attributes of the log data selected by the selection unit.

A second aspect of the present disclosure is a log data analysis method wherein a processor executes processing of: acquiring log data in which a user action and one or more attributes associated with the action are described; selecting a combination of the attributes of the acquired log data on the basis of the action of the log data and the unique number in the combination of the attributes associated with the action; and analyzing the log data by a predetermined language model using the selected combination of the attributes of the log data.

A third aspect of the present disclosure is a log data analysis program for causing a computer to function as the log data analysis device of the first aspect of the present disclosure.

### Advantageous Effects of Invention

According to the disclosed technology, it is possible to provide a log data analysis device, a log data analysis method, and a log data analysis program for analyzing log data by a combination including many action characteristics while suppressing a calculation cost by selecting a combination of appropriate number of attributes for a model to be used for analysis.

### BRIEF DESCRIPTION OF DRAWINGS

FIG. 1 is a block diagram illustrating a hardware configuration of a log data analysis device according to an embodiment.

FIG. 2 is a block diagram illustrating an example of functional configurations of the log data analysis device.

FIG. 3 is a diagram illustrating an example of log data to be analyzed by the log data analysis device according to the present embodiment.

FIG. 4A is a diagram illustrating an expression example of a user action using only “channel” as an attribute.

FIG. 4B is a diagram illustrating an expression example of a user action using all of “channel”, “action”, and each event as attributes.

FIG. 4C is a diagram illustrating an expression example of a user action using “Event 1” and “Event 2” as attributes.

FIG. 5 is a diagram for explaining selection processing by a selection unit.

FIG. 6 is a diagram for explaining selection processing by the selection unit.

FIG. 7 is a diagram illustrating a cardinality estimation method by the selection unit.

FIG. 8 is a diagram illustrating an example of equally dividing a target number of words for each data source.

FIG. 9 is a diagram illustrating an example in which the target number of words is allocated by a ratio of a maximum number of words for each data source.

FIG. 10 is a flowchart illustrating a flow of log data analysis processing by the log data analysis device.

FIG. 11 is a diagram illustrating a structure of log data used for describing a specific example of log data analysis processing by the log data analysis device and the number of words of single attribute.

FIG. 12 is a diagram illustrating comparison among a case where log data is used as it is, a case where the simple method illustrated in FIG. 5 is used, and a case where the method described in the present embodiment is used.

### DESCRIPTION OF EMBODIMENTS

Hereinafter, an example of an embodiment of the disclosed technology will be described with reference to the drawings. In the drawings, the same reference signs are assigned to the same or equivalent components and portions. In addition, dimensional ratios in the drawings are exaggerated for convenience of description, and may be different from actual ratios.

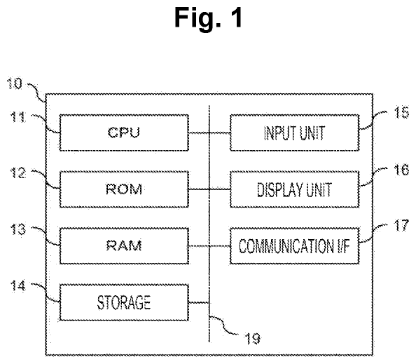

FIG. 1 is a block diagram illustrating a hardware configuration of a log data analysis device 10 of the present embodiment. The log data analysis device 10 according to the present embodiment is a device that acquires log data in which a user action and one or more attributes associated with the action are described, executes analysis processing on the acquired log data, and outputs an analysis result. The analysis processing executed by the log data analysis device 10 is processing of analyzing a characteristic tendency of the user action by analyzing the log data using a language model. In the present embodiment, the language model can include both a model using statistics and a model using a neural network. The log data analysis device 10 according to the present embodiment uses, for example, word2vec, doc2vec, Transformer, BERT, or the like as the language model. With an analysis of the characteristic tendency of the user action using the language model by the log data analysis device 10, it is possible to propose the next action to the user.

In addition, the log data analysis device 10 of the present embodiment selects an appropriate combination of attributes when applying the log data to the language model. Then, the log data analysis device 10 of the present embodiment applies the log data having the selected combination to the language model. By applying the log data having the selected combination to the language model, the log data analysis device 10 of the embodiment can analyze the log data by the combination including many action characteristics while suppressing the calculation volume. A specific configuration and operation of the log data analysis device 10 will be described in detail later.

A general-purpose computer device such as a server computer or a personal computer (PC) is applied to the log data analysis device 10 according to the present embodiment.

As illustrated in FIG. 1, the log data analysis device 10 includes a central processing unit (CPU) 11, read only memory (ROM) 12, random access memory (RAM) 13, a storage 14, an input unit 15, a display unit 16, and a communication interface (I/F) 17. The components are communicatively connected to each other via a bus 19.

The CPU 11 is a central processing unit, and executes various programs and controls each unit. That is, the CPU 11 reads a program from the ROM 12 or the storage 14, and executes the program using the RAM 13 as a working area. The CPU 11 performs control of each of the components described above and various types of arithmetic processing in accordance with a program stored in the ROM 12 or the storage 14. In the present embodiment, the ROM 12 or the storage 14 stores a log data analysis program for analyzing log data.

The ROM 12 stores various programs and various types of data. The RAM 13 is a work area and temporarily stores programs or data. The storage 14 includes a storage device such as a hard disk drive (HDD) or a solid state drive (SSD) and stores various programs including an operating system and various types of data.

The input unit 15 includes a pointing device such as a mouse and a keyboard and is used to perform various inputs.

The display unit 16 is, for example, a liquid crystal display and displays various types of information. The display unit 16 may function as the input unit 15 by adopting a touchscreen system.

The communication interface 17 is an interface for communicating with other devices. For the communication, for example, a wired communication standard such as Ethernet (registered trademark) or FDDI, or a wireless communication standard such as 4G, 5G, or Wi-Fi (registered trademark) is used.

Next, functional configurations of the log data analysis device 10 will be described.

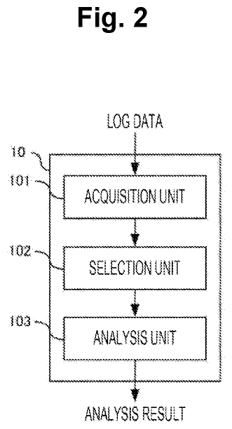

FIG. 2 is a block diagram illustrating an example of functional configurations of the log data analysis device 10.

As illustrated in FIG. 2, the log data analysis device 10 includes an acquisition unit 101, a selection unit 102, and an analysis unit 103 as functional configurations. Each of the functional configurations is implemented by the CPU 11 reading the log data analysis program stored in the ROM 12 or the storage 14, loading the time-series data analysis program onto the RAM 13, and executing the time-series data analysis program.

The acquisition unit 101 acquires log data to be analyzed by the log data analysis device 10. The acquisition unit 101 sends the acquired log data to the selection unit 102.

The selection unit 102 performs selection processing on the log data sent from the acquisition unit 101. By performing selection processing on the log data sent from the acquisition unit 101, the selection unit 102 can cause the analysis unit 103 to analyze the log data by a combination including many action characteristics while suppressing the calculation volume in the analysis unit 103.

Here, selection processing by the selection unit 102 will be described in detail.

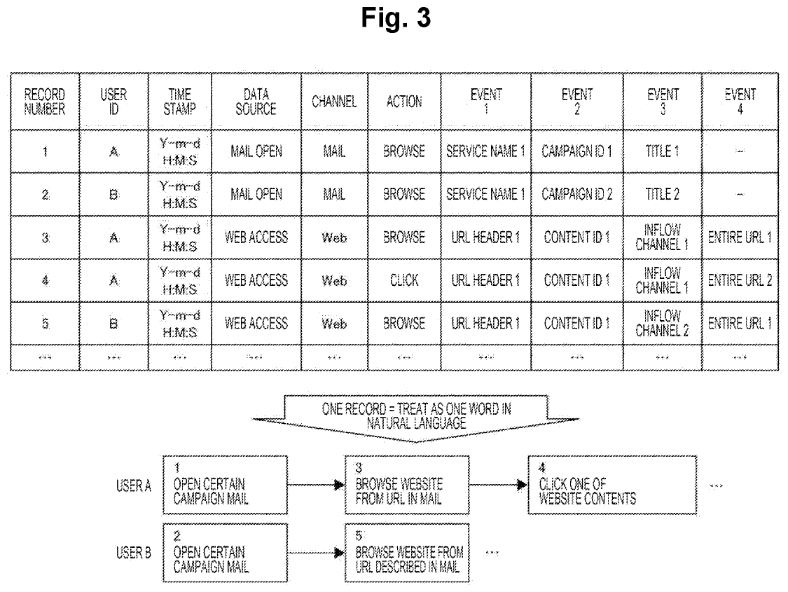

FIG. 3 is a diagram illustrating an example of log data to be analyzed by the log data analysis device 10 according to the present embodiment. The log data analysis device 10 treats one record of the log data as one word in natural language, and performs analysis processing of the log data using the language model.

Taking actions of User A in the log data of FIG. 3 as an example, the actions are described in the log data that the User A opens a certain campaign mail (Record 1), browses a website by selecting a URL described in the mail (Record 3), and clicks content in which Content ID 1 is set in the browsed website (Record 4). In addition, taking record number 2 of the log data of FIG. 3 as an example, actions of User B of opening a certain campaign mail (record 2) and browsing a website by selecting a URL described in the mail (record 5) are described in the log data.

When the log data as illustrated in FIG. 3 is to be analyzed, it is desirable to select an attribute to be used so that the content of the user action can be identified at an appropriate granularity according to the language model used for analysis. In the following description, the number of unique values of the entire data when the value of the combination of attributes is regarded as one word is referred to as the number of words. The number of words is an index indicating granularity. Here, when log data is to be analyzed, a case where only any one of attributes is used and a case where all attributes are used are considered.

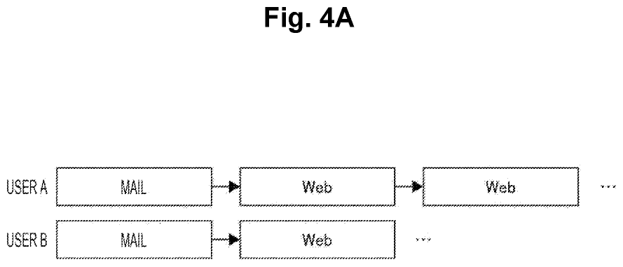

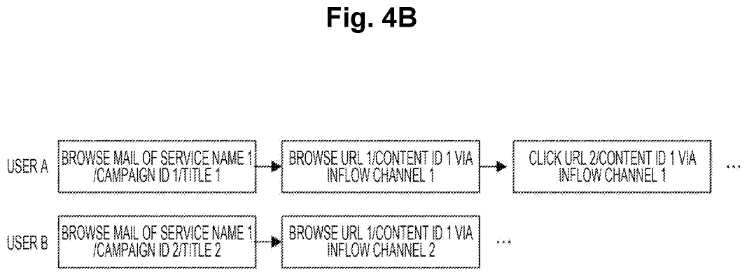

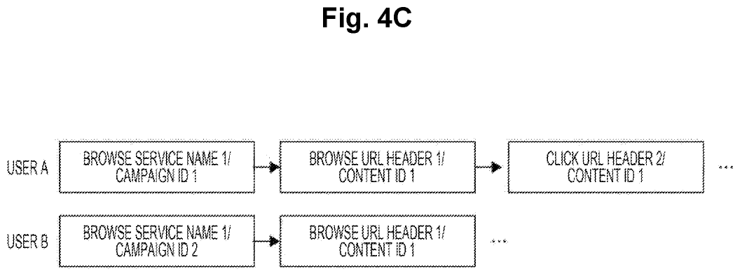

FIG. 4A is a diagram illustrating an expression example of a user action using only “channel” as an attribute. When only one attribute is used, if only “channel” in the log data of FIG. 3 is used, the user actions are aggregated into “mail” or “web” as illustrated in FIG. 4A. However, when only one attribute is used, the resolution of the user actions is insufficient, the characteristic actions of the user cannot be identified, and there is a possibility that a significant analysis result cannot be obtained even if analysis is performed.

FIG. 4B is a diagram illustrating an expression example of a user action using all of “channel”, “action”, and each event as attributes. When all the attributes are used, as illustrated in FIG. 4B, the user actions can be finely expressed, but the resolution of the actions of the user is excessive, and many actions are regarded as unique, and there is a possibility that a statistical tendency cannot be obtained. In addition, when all the attributes are used, the calculation cost in the analysis processing in the analysis unit 103 becomes enormous.

Therefore, in the present embodiment, the selection unit 102 selects the attribute to be used so that the granularity (the number of words) is appropriate for the language model to be used for analysis using the language model in the analysis unit 103. FIG. 4C is a diagram illustrating an expression example of a user action using “Event 1” and “Event 2” as attributes. By selecting the attribute to be used for analysis in this manner, the statistical tendency of the action of the user is appropriately reflected, and the attribute is suitable for analysis using the language model. In addition, by selecting the attribute to be used for analysis, the calculation volume in the analysis processing in the analysis unit 103 can be suppressed as compared with the case where all the attributes are used.

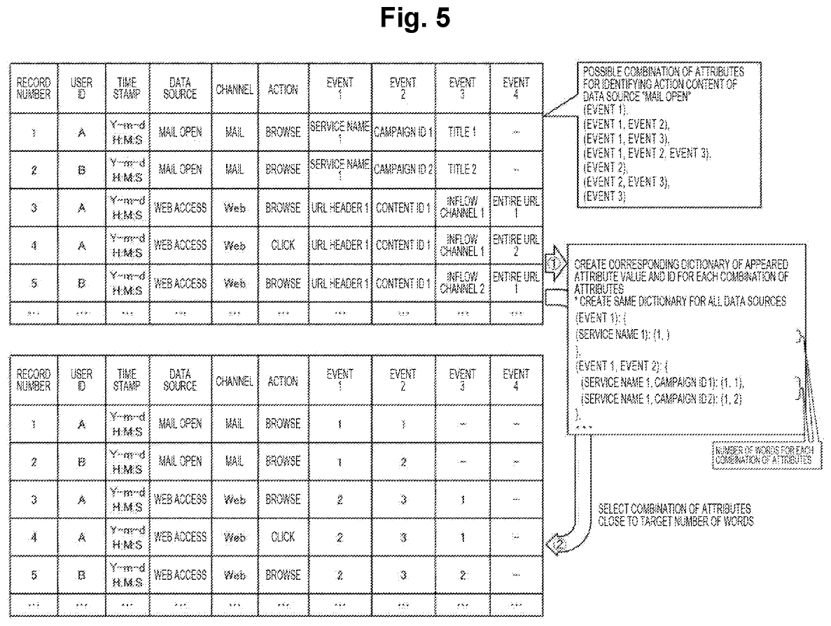

A specific example of selection processing of the selection unit 102 will be described. FIG. 5 is a diagram for explaining selection processing by the selection unit 102. The selection processing described with reference to FIG. 5 is also referred to as a simple method in the following description. In the log data illustrated in FIG. 3, there are the following seven candidate combinations of attributes for identifying the action content of the data source “mail open”.
(Event 1),
(Event 1, Event 2),
(Event 1, Event 3),
(Event 1, Event 2, Event 3),
(Event 2),
(Event 2, Event 3),
(Event 3)

The selection unit 102 performs processing of creating a corresponding dictionary of the appeared attribute value and ID for each combination of the attributes of the log data. The selection unit 102 performs processing on other data sources in the same manner. FIG. 5 also illustrates log data in a state in which each attribute value is replaced with an ID.

Then, the selection unit 102 selects a combination of the attributes close to the target number of words. The target number of words may depend on an analysis method or an analysis policy of the analysis unit 103 using language models. For example, when BERT4Rec is used as a language model, the target number of words is set to 30,000. Of course, since the analysis unit 103 performs analysis in which user actions are captured in detail, a larger or smaller target number of words may be set.

However, in the simple method illustrated in FIG. 5, there is a possibility that the dictionary information becomes enormous when the character string length or the combination pattern of the attributes of each item in the log data is large. In other words, this approach may increase dictionary information each time data is added. Then, when the dictionary information cannot be stored in the RAM 13, the performance of the processing is greatly deteriorated due to the reasons such that the dictionary information is stored in the storage 14 and full scanning is repeated.

Therefore, in the present embodiment, the selection unit 102 updates a cardinality estimation object with the appeared action content for each combination of the attributes of the log data. The cardinality estimation object indicates a data structure and a function group generated using a technology such as HyperLogLog (HLL) and an improved version of HLL, for example. The selection unit 102 can estimate the number of pieces of unique data in the combination of the attributes by updating the cardinality estimation object with the appeared action content for each combination of the attributes of the log data. In the present embodiment, since the log data is analyzed using the language model, the number of pieces of unique data can also be referred to as the number of words.

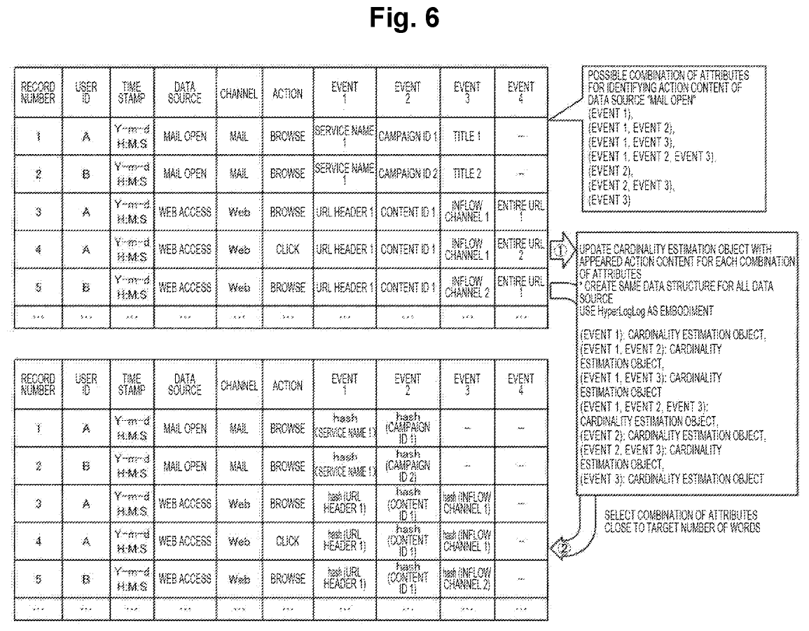

FIG. 6 is a diagram for explaining selection processing by the selection unit 102. The selection unit 102 performs processing of updating the cardinality estimation object with the appeared action content for each combination of attributes. The selection unit 102 performs processing of creating a data structure for other data sources in the same manner.

Then, the selection unit 102 estimates the number of words by the cardinality estimation objects of each combination. In addition, the selection unit 102 uses a hash function for the identification of each attribute value and also uses the hash value for updating the HLL. FIG. 6 also illustrates log data in a state in which each attribute value is identified by a hash function.

When a hash value of an attribute value of log data such as a character string is given to the cardinality estimation object, the cardinality estimation object calculates a characteristic of the hash value using a function without accumulating the hash value itself, and accumulates or updates the characteristic as a statistical value. In the HLL, when the hash value is regarded as a bit string, a statistical value indicating the number of consecutive zeros from the head is used. In the present embodiment, since only the statistical value is accumulated or updated instead of the hash value itself, the hash value pattern can be suppressed to constant memory consumption at most.

In addition, since the cardinality estimation object can be created and merged for each fragment of the log data of the user, it is easy to parallelize estimation processing of the number of words for each pattern of the combination of attributes.

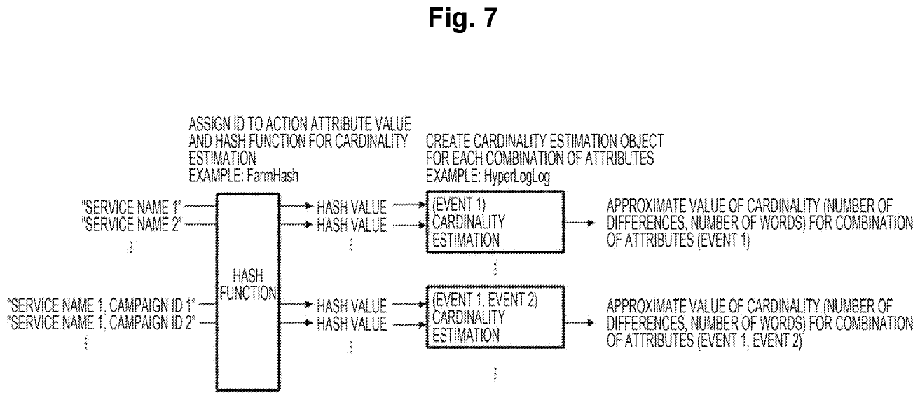

FIG. 7 is a diagram illustrating a cardinality estimation method by the selection unit 102. The cardinality can also be referred to as the number of differences or the number of words. The selection unit 102 generates a hash value by using a hash function for ID assignment to the action attribute value and cardinality estimation for each combination of attributes. The action attribute value refers to a value on the log data stored for each attribute. In the present embodiment, FarmHash is used as the hash function, but another hash function may be used.

When generating the hash value, the selection unit 102 generates a cardinality estimation object for each combination of attributes.

For example, when the cardinality is estimated only for the action attribute value of one attribute, the selection unit 102 generates a hash value using a hash function for the action attribute value, and performs cardinality estimation for the generated hash value. Furthermore, when cardinality is estimated for a combination of action attribute values of two attributes, the selection unit 102 generates a hash value using a hash function for the combined action attribute value, and performs cardinality estimation for the generated hash value.

The selection unit 102 can obtain the approximate value of the cardinality for each combination of the attributes by generating the cardinality estimation object for each combination of the attributes. Here, the selection unit 102 can perform decentralized processing of the hash value generation and the update of the cardinality estimation object by dividing the input log data in units of rows. Then, the selection unit 102 can estimate the cardinality of the entire log data by merging the cardinality estimation object after the decentralized processing.

After giving all the hash values of the attribute values obtained from the log data to the cardinality estimation objects for each data source and each of the listed attribute combinations, the selection unit 102 can calculate the estimated value of the cardinality from the statistical value accumulated in each cardinality estimation object. The attribute value is a value combined as one character string with a separator (for example, comma) when combining a plurality of attributes.

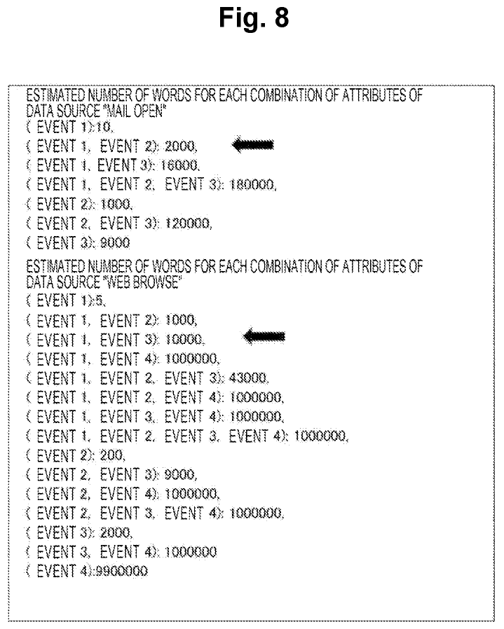

The sum of the number of words for all data sources is required to be equal to or less than the target number of words. Therefore, the selection unit 102 may equally divide the target number of words for each data source. For example, the importance of each data source of the user action log or the content of each attribute value is unknown, and thus for the time being, the target number of words is equally divided for each data source upon proceeding analysis by supposing that all the data sources are equivalent. FIG. 8 is a diagram illustrating an example of equally dividing the target number of words for each data source. FIG. 8 illustrates the estimated number of words for each combination of attributes.

For example, assuming that the total target number of words is 30,000, when there are two types of data sources, the target number of words for each type is 15,000. Then, the selection unit 102 selects the largest combination of attributes that does not exceed the target number of words. In the example of FIG. 8, a combination of (Event 1, Event 2) is selected as the combination of the attributes of the record of the data source “mail open”, and (Event 1, Event 3) is selected as the combination of the attributes of the record of the data source “web browse”.

Note that the selection unit 102 may arbitrarily divide the number of words for each data source instead of equally dividing the number of words. For example, when the importance level of each data source or the content of each attribute can be grasped, the number of words is arbitrarily divided when adjustment is performed so that a user action characteristic can be expressed. That is, assuming that the total target number of words is 30,000, when there are two types of data sources, the 10,000 words may be allocated to one data source and 20,000 words may be allocated to another data source instead of setting each target number of words to 15,000 words.

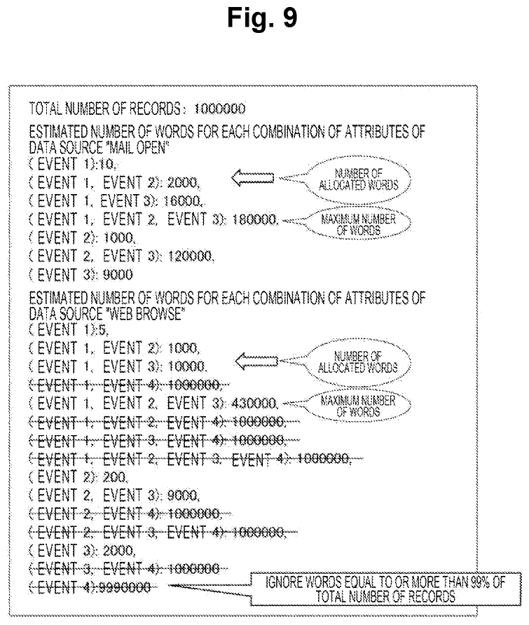

Furthermore, when the number of words of single attribute is close to the total number of records, the selection unit 102 determines that most records are highly possibly unique and having no statistical significance, and thus may ignore the attribute. Specifically, the selection unit 102 may allocate the target number of words by a ratio of a maximum value of the number of words for each data source (hereinafter, also referred to as “maximum number of words”), after ignoring the number of words of single attribute the ratio to the total number of records of which exceeding a threshold. For example, in a case where the importance level for each data source or the content of each attribute value is unknown but a data source having a large number of words can be assumed to indicate a user action characteristic in more detail, the target number of words is allocated by a ratio of the maximum number of words for each data source. FIG. 9 is a diagram illustrating an example in which a target number of words is allocated by a ratio of a maximum number of words for each data source. FIG. 9 illustrates the estimated number of words for each combination of attributes.

For example, when the total number of records is 1,000,000 and the threshold is 99%, the number of words of single attribute (unique number) exceeding 99% of the total number of records, that is, 990,000 is ignored. The strike-through lines illustrated in FIG. 9 indicate that the number of words of single attribute of “Event 4” is the same (100%) with respect to the total number of records, and thus the attribute combination including Event 4 is not set as a comparison target of the maximum number of words. In addition, when the total target number of words is 30,000, the maximum number of words whose data source does not exceed the threshold of “mail open” is 180,000, and the maximum number of words whose data source does not exceed the threshold of “web browse” is 430,000. As a result of allocation by the ratio of maximum number of words (180,000:430,000), the selection unit 102 allocates 8,852 and 21,148 words for each data source, respectively, which are calculated by the ratio of the maximum number of words of “mail open” and “web browse”. Then, the selection unit 102 selects, for each data source, a combination of the attributes that maximizes the number of words that does not exceed the maximum number of words. In the example illustrated in FIG. 9, a combination of (Event 1, Event 2) is selected for the data source “mail open”, and (Event 1, Event 2, Event 3) is selected for the combination of the attributes of the record of the data source “web browse”.

The analysis unit 103 analyzes the log data on the basis of the combination of the attributes selected by the selection unit 102. As described above, the analysis unit 103 analyzes the log data using a language model such as word2vec, doc2vec, Transformer, BERT, or the like, for example. By analyzing the log data with the combination of the attributes selected by the selection unit 102 using the language model, the analysis unit 103 can analyze the tendency of the user action.

With such a configuration, the log data analysis device 10 can suppress the calculation cost as compared with a case where all the attributes are used, and can analyze the log data by a combination including many action characteristics.

Next, the operation of the log data analysis device 10 will be described.

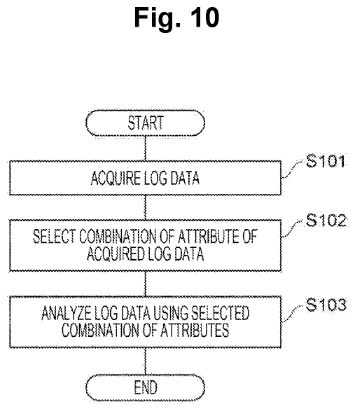

FIG. 10 is a flowchart illustrating a flow of log data analysis processing by the log data analysis device 10. Log data analysis processing is performed by the CPU 11 of reading a log data processing program from the ROM 12 or the storage 14, developing the data processing program in the RAM 13, and executing the data processing program.

First, in step S101, the CPU 11 acquires log data to be analyzed from the outside.

Following step S101, the CPU 11 selects a combination of the attributes of the acquired log data in step S102. The CPU 11 selects the attribute to be used so that the granularity (the number of words) becomes appropriate for a language model to be used for analysis using the language model. Specifically, the CPU 11 updates the cardinality estimation object with the appeared action content for each combination of the attributes of the log data. Then, the CPU 11 selects a combination of the attributes close to the target number of words on the basis of the result of updating the cardinality estimation object.

Following step S102, the CPU 11 analyzes the log data using the language model for the selected combination of attributes in step S103.

Next, a specific example of log data analysis processing by the log data analysis device 10 will be described.

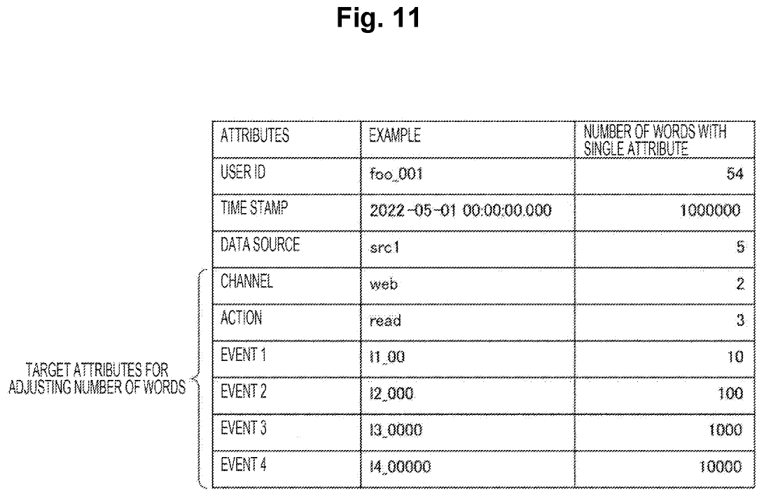

FIG. 11 is a diagram illustrating a structure of log data used for describing a specific example of log data analysis processing by the log data analysis device 10 and the number of words of single attribute. Here, it is assumed that log data of a total of 1,000,000 records is used.

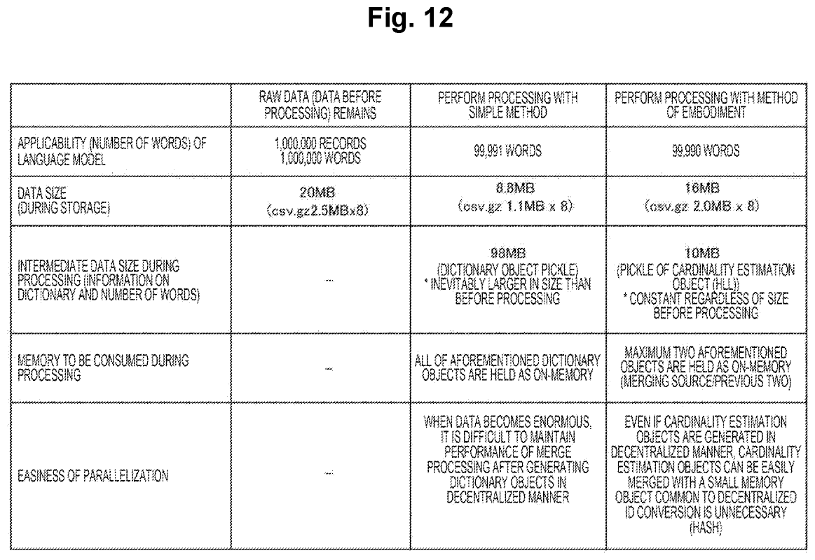

FIG. 12 is a diagram illustrating comparison among a case where log data is used as it is, a case where the simple method illustrated in FIG. 5 is used, and a case where the method described in the present embodiment is used. The target number of words is 100,000.

When the log data of 1,000,000 records is used as it is, applicability (the number of words) of the language model is 1,000,000 records, that is, 1,000,000 words, and a data size is 20 megabytes (MB).

When the simple method is used, the applicability (the number of words) of the language model is 99,991 words, the data size is 8.8 MB, and the intermediate data size in which the information on the dictionary and the number of words at the time of the processing is held is 98 MB. That is, when the simple method is used, the size may be larger than that before processing. In addition, when the simple method is used, it is necessary to hold all the dictionary objects in the memory. When the dictionary object cannot be held in the memory, it is inefficient, but there may be a method of changing to hold the dictionary object in a hard disk (storage) instead of the memory. However, the data in the storage needs to be searched many times, and it becomes difficult to maintain performance when the data is large. Although decentralized processing is also conceivable for performance improvement, it is necessary to merge the dictionary objects created for each data fragment into one, and it is also difficult to maintain performance of the processing for that purpose.

In contrast to the above, when the method described in the present embodiment is used, the applicability (the number of words) of the language model is 99,990 words, the data size is 16 MB, while the intermediate data size in which the information on the dictionary and the number of words at the time of the processing is held is 10 MB. When the method described in the present embodiment is used, the intermediate data size is constant regardless of the size before the processing. In addition, when the method described in the present embodiment is used, it is necessary to hold at most two objects in the memory, but the data size thereof is smaller than that of the simple method. Then, when the method described in the present embodiment is used, even if the cardinality estimation objects are generated in a decentralized manner, the cardinality estimation objects can be easily merged with a small memory, and an object common to the decentralized ID conversion is unnecessary.

From the above, the method described in the present embodiment can suppress the data volume to be held as compared with the case where the log data is used as it is and the case where the simple method illustrated in FIG. 5 is used. Then, the method described in the present embodiment suppresses the data volume to be held, so that the calculation volume can be suppressed as compared with the case where the log data is used as it is and the case where the simple method illustrated in FIG. 5 is used. In addition, the method described in the present embodiment can analyze the log data by a combination including many action characteristics by selecting a combination of attributes that is close to the number of words suitable for the language model used for analysis.

Note that the log data analysis processing, which is executed by the CPU reading software (program) in each of the above embodiments, may be executed by various processors other than the CPU. Examples of a processor in this case include a programmable logic device (PLD) in which a circuit configuration can be changed after manufacturing, such as a field-programmable gate array (FPGA), a dedicated electric circuit that is a processor having a circuit configuration exclusively designed to execute specific processing, such as an application specific integrated circuit (ASIC), and the like. In addition, the log data analysis processing may be executed by one of the various processors or may be executed by a combination of two or more processors of the same type or different types (e.g., a combination of a plurality of FPGAs or a combination of a CPU and an FPGA). More specifically, the hardware structures of these various processors are electric circuits in which circuit elements such as semiconductor elements are combined.

In each of the above embodiments, the aspect in which the log data analysis program is stored (installed) in advance in the storage 14 has been described, but this is not restrictive. The program may be provided in a form stored in a non-transitory storage medium such as a compact disk read only memory (CD-ROM), a digital versatile disk read only memory (DVD-ROM), or a Universal Serial Bus (USB) memory. In addition, the program may be downloaded from an external device via a network.

With regard to the above-described embodiments, the following supplementary items are further disclosed.

### Supplement 1

A log data analysis device including:
a memory; and
at least one processor connected to the memory,
the processor being configured to
acquire log data in which a user action and one or more attributes associated with the action are described,
select a combination of the attributes of the acquired log data on a basis of the action of the log data and a unique number in the combination of the attributes associated with the action, and
analyze the log data by a predetermined language model using the selected combination of the attributes of the log data.

### Supplement 2

A non-transitory storage medium storing a program executable by a computer to execute a log data analysis processing, in which the log data analysis processing
acquires log data in which a user action and one or more attributes associated with the action are described,
selects a combination of the attributes of the acquired log data on a basis of the action of the log data and a unique number in the combination of the attributes associated with the action, and
analyzes the log data by a predetermined language model using the selected combination of the attributes of the log data.

### REFERENCE SIGNS LIST

10 Log data analysis device
101 Acquisition unit
102 Selection unit
103 Analysis unit

1. A log data analysis device comprising:
an acquisition circuitry that acquires log data, the log data describing a user action and one or more attributes associated with the action;
a selection circuitry that selects a combination of the attributes of the log data acquired by the acquisition circuitry on a basis of the action of the log data and a number of pieces of unique data in the combination of the attributes associated with the action; and
an analysis circuitry that analyzes the log data by a predetermined language model using the combination of the attributes of the log data selected by the selection circuitry.

2. The log data analysis device according to claim 1, wherein the selection unit estimates the number of pieces of unique data using appeared action contents for each combination of the attributes, and selects the combination of the attributes on a basis of a result of the estimation.

3. The log data analysis device according to claim 1, wherein the selection circuitry allocates a target number of records in the analysis by the analysis circuitry to each of the actions on a basis of a predetermined rule.

4. The log data analysis device according to claim 3, wherein the selection unit equally divides the target number of records in the analysis by the analysis circuitry to each of the actions.

5. The log data analysis device according to claim 3, wherein the selection circuitry allocates the target number of records in the analysis by the analysis circuitry on a basis of a ratio of a maximum value of the number of pieces of unique data for each of the actions.

6. The log data analysis device according to claim 1, wherein the selection circuitry estimates the number of pieces of unique data in a state where an attribute value of the log data is hashed.

7. A log data analysis method for causing a processor to execute processing of
acquiring log data in which a user action and one or more attributes associated with the action are described,
selecting a combination of the attributes of the acquired log data on a basis of the action of the log data and a unique number in the combination of the attributes associated with the action, and
analyzing the log data by a predetermined language model using the selected combination of the attributes of the log data.

8. (canceled)

9. The log data analysis method according to claim 7, wherein the number of pieces of unique data is estimated using appeared action contents for each combination of the attributes, and the combination of the attributes is selected on a basis of a result of the estimation.

10. The log data analysis method according to claim 7, wherein a target number of records is allocated in the analysis to each of the actions on a basis of a predetermined rule.

11. The log data analysis method according to claim 10, wherein the target number of records is equally divided in the analysis to each of the actions.

12. The log data analysis device according to claim 10, wherein the target number of records is allocated in the analysis on a basis of a ratio of a maximum value of the number of pieces of unique data for each of the actions.

13. The log data analysis device according to claim 1, wherein the number of pieces of unique data is estimated in a state where an attribute value of the log data is hashed.

14. A computer-readable non-transitory recording medium storing computer-executable program instructions that when executed by a processor cause a computer to execute a log data analysis program comprising:
acquiring log data, the log data describing a user action and one or more attributes associated with the action;
selecting a combination of the attributes of the log data acquired by the acquisition unit circuitry on a basis of the action of the log data and a number of pieces of unique data in the combination of the attributes associated with the action; and
analyzing the log data by a predetermined language model using the combination of the attributes of the log data selected by the selection unit circuitry.

15. The computer-readable non-transitory recording medium according to claim 14 wherein the log data analysis method further comprises:
the number of pieces of unique data is estimated using appeared action contents for each combination of the attributes, and the combination of the attributes is selected on a basis of a result of the estimation.

16. The computer-readable non-transitory recording medium according to claim 14 wherein the log data analysis method further comprises:
a target number of records is allocated in the analysis to each of the actions on a basis of a predetermined rule.

17. The computer-readable non-transitory recording medium according to claim 16 wherein the log data analysis method further comprises:
the target number of records is equally divided in the analysis to each of the actions.

18. The computer-readable non-transitory recording medium according to claim 16 wherein the log data analysis method further comprises:
the target number of records is allocated in the analysis on a basis of a ratio of a maximum value of the number of pieces of unique data for each of the actions.

19. The computer-readable non-transitory recording medium according to claim 14 wherein the log data analysis method further comprises:
the number of pieces of unique data is estimated in a state where an attribute value of the log data is hashed.

20. The log data analysis device according to claim 1, wherein the section circuitry updates a cardinality estimation object with a behavior content for each combination of the attributes.

21. The log data analysis method according to claim 7, wherein a cardinality estimation object is updated with a behavior content for each combination of the attributes.
